(19) United States
(12) Patent Application Publication
(10) Pub. No.: US 2015/0119239 A1
(43) Pub. Date: Apr. 30, 2015

(54) AGROCHEMICAL COMPOSITIONS

(71) Applicant: BASF SE, Ludwigshafen (DE)

(72) Inventors: Markus Gewehr, Kastellaun (DE); Cyrill Zagar, Raleigh, NC (US); Scott Peoples, Raleigh, NC (US)

(21) Appl. No.: 14/381,075

(22) PCT Filed: Feb. 27, 2013
(86) PCT No.: PCT/EP2013/053933

§ 371 Date: Aug. 26, 2014

Related U.S. Application Data
(60) Provisional application No. 61/605,196, filed on Mar. 1, 2012.

(51) Int. Cl. A01N 43/90; A01N 43/54; A01N 43/38; A01N 43/84; A01N 37/18; A01N 43/56; A01N 43/40; A01N 43/32; A01N 43/78; A01N 43/653; A01N 43/82

(52) U.S. Cl. CPC A01N 43/90; A01N 43/653; A01N 43/54; A01N 43/38; A01N 43/84; A01N 43/82; A01N 43/56; A01N 43/40; A01N 43/32; A01N 43/78; A01N 37/18
USPC 504/100; 504/246; 504/273; 504/243; 504/286; 504/225; 504/236; 504/265; 504/167; 504/169; 504/170; 504/168

(57) ABSTRACT

The present invention related to an agrochemical composition comprising at least one protoporphyrinogen-IX oxidase inhibitor as defined in the claims and description and at least one inhibitor of complex II of the respiratory chain as defined in the claims and description. The invention further relates to the use of this composition for controlling undesired vegetation, for the desiccation and/or defoliation of plants, for controlling phytopathogenic fungi and for increasing the health of plants. The invention further relates to a method for controlling undesired vegetation, to a method for the desiccation and/or defoliation of plants, to a method for controlling phytopathogenic fungi and to a method for increasing the health of plants by using said composition.

The present invention related to an agrochemical composition comprising at least one protoporphyrinogen-IX oxidase inhibitor as defined below and at least one inhibitor of complex II of the respiratory chain as defined below. The invention further relates to the use of this composition for controlling undesired vegetation, for the desiccation and/or defoliation of plants, for controlling phytopathogenic fungi and for increasing the health of plants. The invention further relates to a method for controlling undesired vegetation, to a method for the desiccation and/or defoliation of plants, to a method for controlling phytopathogenic fungi and to a method for increasing the health of plants by using said composition.

Hereinbelow, the protoporphyrinogen-IX oxidase inhibitor A will also be named “PPO inhibitor A” or “herbicide A” or “component A” or “compound A”.

Further, the “inhibitor of complex II of the respiratory chain” will also be named “respiration inhibitor B” or “fungicide B” or “component B” or “compound B”.

In the case of crop protection compositions, it is desirable in principle to increase the specific activity of an active compound and the reliability of the effect. It is particularly desirable for the crop protection composition to control the harmful plants effectively, but at the same time to be compatible with the useful plants in question. Also desirable is a broad spectrum of activity allowing the simultaneous control of harmful plants. Frequently, this cannot be achieved using a single active compound.

With many highly effective herbicides, there is the problem that their compatibility with useful plants, in particular dicotyledonous crop plants, such as cotton, oilseed rape and graminaceous plants, such as barley, millet, corn, rice, wheat and sugar cane, is not always satisfactory, i.e. in addition to the harmful plants, the crop plants, too, are damaged on a scale which cannot be tolerated. By reducing the application rates, the useful plants are spared; however, naturally, the extent of the control of harmful plants decreases, too.

It is known that special combinations of different specifically active herbicides result in enhanced activity of an herbicide component in the sense of a synergistic effect. In this manner, it is possible to reduce the application rates of herbicidal active compounds required for controlling the harmful plants.

Furthermore, it is known that in some cases joint application of specifically acting herbicides with other organic active compounds allows better crop plant compatibility to be achieved. In these cases, the active compounds act as antidotes or antagonists and are also referred to as safeners, since they reduce or even prevent damage to the crop plants.

It is an object of the present invention to provide agrochemical compositions which are highly active against unwanted harmful plants.

This and further objects are achieved by the agricultural active compositions below.

Surprisingly, the compositions according to the invention comprising at least one PPO inhibitor A and at least one respiration inhibitor B as defined herein have better herbicidal activity, i.e. better activity against harmful plants, than would have been expected based on the herbicidal activity observed for the individual compounds, or a broader activity spectrum.

Moreover, the time frame, within which the desired herbicidal action can be achieved, may be expanded by the compositions according to the invention comprising at least one PPO inhibitor A and at least one respiration inhibitor B as defined herein. This allows a more flexibly timed application of the compositions according to the present invention in comparison with the single compounds.

The compositions according to the invention comprising at least one PPO inhibitor A and at least one respiration inhibitor B as defined herein also have better compatibility with useful plants.

Accordingly, the present invention relates to agrochemical active compositions comprising
A) at least one herbicide A selected from the protoporphyrinogen-IX oxidase (PPO) inhibitors acifluorfen (A.1), azafenidin (A.2), bencarbazone (A.3), benzfendizone (A.4), bifenox (A.5), butafenacil (A.6), carfentrazone-ethyl (A.7), chlomethoxyfen (A.8), cinidon-ethyl (A.9), ethoxyfen-ethyl (A.10), fluazolate (A.11), flufenpyr-ethyl (A.12), flumiclorac-pentyl (A.13), flumioxazin (A.14), fluoroglycofen-ethyl (A.15), fluthiacet-methyl (A.16), fomesafen (A.17), halosafen (A.18), lactofen (A.19), oxadiargyl (A.20), oxadiazon (A.21), oxyfluorfen (A.22), pentoxazone (A.23), profluazol (A.24), pyraclonil (A.25), pyraflufen-ethyl (A.26), saflufenacil (A.27), sulfentrazone (A.28), thidiazimin (A.29), 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) (A.30), ethyl[3-[2-chloro-4-fluoro-5-(1-methyl-6-trifluoromethyl-2,4-dioxo-1,2,3,4-tetrahydro-pyrimidin-3-yl)phenoxy]-2-pyridyloxy]acetate (CAS 353292-31-6; S-3100) (A.31), N-ethyl-3-(2,6-dichloro-4-trifluoro-methylphenoxy)-5-methyl-1H-pyrazole-1-carboxamide (CAS 452098-92-9) (A.32), N-tetrahydrofurfuryl-3-(2,6-dichloro-4-trifluoromethyl-phenoxy)-5-methyl-1H-pyrazole-1-carboxamide (CAS 915396-43-9) (A.33), N-ethyl-3-(2-chloro-6-fluoro-4-trifluoromethyl-phenoxy)-5-methyl-1H-pyrazole-1-carboxamide (CAS 452099-05-7) (A.34), N-tetrahydro-furfuryl-3-(2-chloro-6-fluoro-4-trifluoro-methylphenoxy)-5-methyl-1H-pyrazole-1-carboxamide (CAS 45100-03-7) (A.35), (Z)-4-[2-Chloro-5-(4-chloro-5-difluoromethoxy-1-methyl-1H-pyrazol-3-yl)-4-fluoro-phenoxy]-3-methyl-but-2-enoic acid methyl ester (A.36), and their agriculturally acceptable salts;
   and
B) at least one fungicide B selected from the inhibitors of complex II of the respiratory chain benodanil (B.1), bixafen (B.2), boscalid (B.3), carboxin (B.4), fenfuram (B.5), fluopyram (B.6), flutolanil (B.7), fluxapyroxad (B.8), furametpyr (B.9), isopyrazam (B.10), mepronil (B.11), oxycarboxin (B.12), penthiopyrad (B.13), penflufen (B.14), sedaxane (B.15), thifluzamide (B.16), 3-difluoromethyl-1-methyl-1H-pyrazole-4-carboxylic acid (9-dichloromethylene-1,2,3,4-tetrahydro-1,4-methano-naphthalen-5-yl)-amide (B.17), and 3-difluoromethyl-1-methyl-1H-pyrazole-4-carboxylic acid (2-(2,4-dichloro-phenyl)-2-methoxy-1-methyl-ethyl)-amide (B.18).

The composition according to the invention may be a physical mixture of the at least one compound A and the at least one compound B. Accordingly, the invention also provides a mixture comprising at least one compound A and at least one compound B. However, the composition may also be any combination of at least one compound A with at least one compound B, it not being required for compounds A and B to be present together in the same formulation.

An example of a composition according to the invention in which the at least one compound A and the at least one compound B are not present together in the same formulation is a combipack. In a combipack, two or more components of a combipack are packaged separately, i.e., not jointly pre-formulated. As such, combipacks include one or more separate containers such as vials, cans, bottles, pouches, bags or canisters, each container containing a separate component for an agrochemical composition. One example is a two-component combipack. Accordingly the present invention also relates to a two-component combipack, comprising a first component which in turn comprises at least one compound A, a liquid or solid carrier and, if appropriate, at least one surfactant and/or at least one customary auxiliary, and a second component which in turn comprises at least one compound B, a liquid or solid carrier and, if appropriate, at least one surfactant and/or at least one customary auxiliary. More details, e.g. as to suitable liquid and solid carriers, surfactants and customary auxiliaries are described below.

The invention relates also to compositions in the form of agrochemical active crop protection compositions comprising at least one PPO inhibitor A and at least one respiration inhibitor B as defined herein, and also at least one liquid and/or solid carrier and/or one or more surfactants and, if desired, one or more further auxiliaries customary for crop protection compositions.

The invention moreover relates to an agrochemical composition for the desiccation/defoliation of plants, comprising the composition as defined herein in such an amount that it acts as a desiccant/defoliant, and at least one inert liquid and/or solid carrier and optionally also at least one surface-active substance.

The invention furthermore also relates to processes for preparing the compositions according to the invention.

The invention also relates seed comprising an agrochemical composition comprising at least one PPO inhibitor A and at least one respiration inhibitor B as defined herein.

The invention furthermore relates to the use of a composition as defined herein for controlling undesired vegetation, and to a method for controlling unwanted vegetation, in particular where crop plants are cultivated, whereas the crops might be resistant to one or more herbicides or to attack by insects owing to genetic engineering or breeding. To be more precise, the invention relates further to a method of controlling undesired vegetation, which comprises allowing a herbicidally effective amount of at least one composition as defined herein to act on plants or parts thereof, their environment (especially on the environment where the plants grow or are to grow) or on propagation material.

The invention also relates to the use of a composition as defined herein for the desiccation and/or defoliation of plants, and to a method for the desiccation or defoliation of plants.

With a view to reducing the application rates and broadening the activity spectrum of the known compounds, it was also an object of the present invention to provide compositions which, at a reduced total amount of active compounds applied, show improved activity against important harmful fungi, in particular for certain indications. It was a further object to provide for mixtures that are useful for the control of specific pathogens in specific important crops that are often susceptible to the attack of pathogens.

Accordingly the invention furthermore relates to the use of the compositions for controlling phytopathogenic fungi and preparations or compositions comprising them, and to a method for controlling phytopathogenic fungi, wherein the fungi or materials, plants, parts thereof, the locus where the plants grow or are to grow or plants' propagation material to be protected from fungal attack are treated with an effective amount of a composition as defined herein.

In crop protection, there is also a continuous need for compositions that improve the health of plants. Healthier plants are desirable since they result among others in better yields and/or a better quality of the plants or crops. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It was therefore also an object of the present invention to provide an agrochemical composition which solves the problems outlined above, and which should, in particular, improve the health of plants, in particular the yield and/or quality of plants.

It has been found that these objects are in part or in whole achieved by using the compositions as defined in the outset.

Accordingly, the present invention also relates to agrochemical composition for increasing the health of a plant comprising in synergistically effective amounts at least one protoporphyrinogen-IX oxidase inhibitor as defined herein and at least one inhibitor of complex II of the respiratory chain as defined herein.

The present invention also relates to the use of the composition according to the invention for improving the health of plants, and to a method for synergistically increasing the health of a plant, in particular the yield of a plant and/or the plant's tolerance against abiotic stress, wherein the plant, the locus where the plant is growing or is expected to grow or plant propagation material from which the plant is to grow is treated with a synergistically effective amount of a composition according to the present invention.

In addition, the invention relates to an agrochemical composition for increasing the health of a plant, comprising a liquid or solid carrier and a composition as defined above.

The present invention also relates to a method for synergistically increasing the health of a plant which is tolerant to a PPO inhibitor A, wherein the plant, the locus where the plant is growing or is expected to grow or plant propagation material from which the plant is to grow is treated with an effective amount of a composition as defined above.

Furthermore, the present invention relates to the use of a composition as defined above for synergistically increasing the yield of a plant, wherein the treated plant is tolerant to a PPO inhibitor A.

Moreover, the present invention relates to the use of a mixture as defined above for synergistically increasing a plant's tolerance against abiotic stress wherein the treated plant is tolerant to a PPO inhibitor A.

The PPO inhibitors A and the respiration inhibitors B as well as their agrochemical action and methods for producing them are generally known. For instance, the commercially available compounds can be found in “The Pesticide Manual, 15th Edition, British Crop Protection Council (2009)” among other publications.

The preferred embodiments of the invention mentioned herein below have to be understood as being preferred either independently from each other or in combination with one another.

The herbicidal activity of PPO inhibitors is based on the inhibition of the protoporphyrinogen-IX-oxidase. These inhibitors belong to the group E of the HRAC classification system.

Preferably, the at least one herbicide A is selected from acifluorfen, bencarbazone, bifenox, carfentrazone-ethyl, cinidon-ethyl, flufenpyr-ethyl, flumiclorac-pentyl, flumioxazin, fluoroglycofen-ethyl, fluthiacet-methyl, fomesafen, halosafen, lactofen, oxadiargyl, oxadiazon, oxyfluorfen, pentoxazone, pyraclonil, pyraflufen-ethyl, saflufenacil, sulfentrazone, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione and their agriculturally acceptable salts.

Among the agriculturally acceptable salts of the above herbicides, preference is given to following compounds:

Acifluorfen: acifluorfen-sodium (A.37).

Thus, more preferably, the at least one herbicide A is selected from acifluorfen, acifluorfen-sodium, bencarbazone, bifenox, carfentrazone-ethyl, cinidon-ethyl, flufenpyr-ethyl, flumiclorac-pentyl, flumioxazin, fluoroglycofen-ethyl, fluthiacet-methyl, fomesafen, halosafen, lactofen, oxadiargyl, oxadiazon, oxyfluorfen, pentoxazone, pyraclonil, pyraflufen-ethyl, saflufenacil, sulfentrazone and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione.

Even more preferably, the at least one herbicide A is selected from acifluorfen, bencarbazone, carfentrazone-ethyl, cinidon-ethyl, flufenpyr-ethyl, flumiclorac-pentyl, flumioxazin, fluoroglycofen-ethyl, fomesafen, halosafen, lactofen, oxyfluorfen, pyraflufen-ethyl, saflufenacil, sulfentrazone, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione and their agriculturally acceptable salts.

Particularly preferably, the at least one herbicide A is selected from acifluorfen, acifluorfen-sodium, bencarbazone, carfentrazone-ethyl, cinidon-ethyl, flufenpyr-ethyl, flumiclorac-pentyl, flumioxazin, fluoroglycofen-ethyl, fomesafen, halosafen, lactofen, oxyfluorfen, pyraflufen-ethyl, saflufenacil, sulfentrazone and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione.

In a particular embodiment, the at least one herbicide A is acifluorfen and the at least one fungicide B has one of the above general or, in particular, one of the below preferred meanings.

In a particular embodiment, the at least one herbicide A is acifluorfen-sodium and the at least one fungicide B has one of the above general or, in particular, one of the below preferred meanings.

In a particular embodiment, the at least one herbicide A is bencarbazone and the at least one fungicide B has one of the above general or, in particular, one of the below preferred meanings.

In a particular embodiment, the at least one herbicide A is carfentrazone-ethyl and the at least one fungicide B has one of the above general or, in particular, one of the below preferred meanings.

In a particular embodiment, the at least one herbicide A is cinidon-ethyl and the at least one fungicide B has one of the above general or, in particular, one of the below preferred meanings.

In a particular embodiment, the at least one herbicide A is flufenpyr-ethyl and the at least one fungicide B has one of the above general or, in particular, one of the below preferred meanings.

In a particular embodiment, the at least one herbicide A is flumiclorac-pentyl and the at least one fungicide B has one of the above general or, in particular, one of the below preferred meanings.

In a particular embodiment, the at least one herbicide A is flumioxazin and the at least one fungicide B has one of the above general or, in particular, one of the below preferred meanings.

In a particular embodiment, the at least one herbicide A is fluoroglycofen-ethyl and the at least one fungicide B has one of the above general or, in particular, one of the below preferred meanings.

In a particular embodiment, the at least one herbicide A is fomesafen and the at least one fungicide B has one of the above general or, in particular, one of the below preferred meanings.

In a particular embodiment, the at least one herbicide A is halosafen and the at least one fungicide B has one of the above general or, in particular, one of the below preferred meanings.

In a particular embodiment, the at least one herbicide A is lactofen and the at least one fungicide B has one of the above general or, in particular, one of the below preferred meanings.

In a particular embodiment, the at least one herbicide A is oxyfluorfen and the at least one fungicide B has one of the above general or, in particular, one of the below preferred meanings.

In a particular embodiment, the at least one herbicide A is pyraflufen-ethyl and the at least one fungicide B has one of the above general or, in particular, one of the below preferred meanings.

In a particular embodiment, the at least one herbicide A is saflufenacil and the at least one fungicide B has one of the above general or, in particular, one of the below preferred meanings.

In a particular embodiment, the at least one herbicide A is sulfentrazone and the at least one fungicide B has one of the above general or, in particular, one of the below preferred meanings.

In a particular embodiment, the at least one herbicide A is 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione and the at least one fungicide B has one of the above general or, in particular, one of the below preferred meanings.

Preferably, the at least one fungicide B is selected from bixafen, boscalid, fluopyram, fluxapyroxad, isopyrazam, penthiopyrad, penflufen, sedaxane, 3-difluoromethyl-1-methyl-1H-pyrazole-4-carboxylic acid (9-dichloromethylene-1,2,3,4-tetrahydro-1,4-methano-naphthalen-5-yl)-amide, and 3-difluoromethyl-1-methyl-1H-pyrazole-4-carboxylic acid (2-(2,4-dichloro-phenyl)-2-methoxy-1-methyl-ethyl)-amide.

More preferably, the at least one fungicide B is selected from bixafen, boscalid, fluxapyroxad, isopyrazam, penflufen, sedaxane, and 3-difluoromethyl-1-methyl-1H-pyrazole-4-carboxylic acid (9-dichloromethylene-1,2,3,4-tetrahydro-1,4-methano-naphthalen-5-yl)-amide.

In a particular embodiment, the at least one fungicide A is bixafen and the at least one herbicide A has one of the above general or, in particular, preferred meanings.

In a particular embodiment, the at least one fungicide A is boscalid and the at least one herbicide A has one of the above general or, in particular, preferred meanings.

In a particular embodiment, the at least one fungicide A is fluxapyroxad and the at least one herbicide A has one of the above general or, in particular, preferred meanings.

In a particular embodiment, the at least one fungicide A is isopyrazam and the at least one herbicide A has one of the above general or, in particular, preferred meanings.

In a particular embodiment, the at least one fungicide A is penflufen and the at least one herbicide A has one of the above general or, in particular, preferred meanings.

In a particular embodiment, the at least one fungicide A is sedaxane and the at least one herbicide A has one of the above general or, in particular, preferred meanings.

In a particular embodiment, the at least one fungicide A is 3-difluoromethyl-1-methyl-1H-pyrazole-4-carboxylic acid (9-dichloromethylene-1,2,3,4-tetrahydro-1,4-methano-naphthalen-5-yl)-amide and the at least one herbicide A has one of the above general or, in particular, preferred meanings.

In particular, the composition according to the invention comprises
A) at least one herbicide A selected from acifluorfen, acifluorfen-sodium, bencarbazone, carfentrazone-ethyl, cinidon-ethyl, flufenpyr-ethyl, flumiclorac-pentyl, flumioxazin, fluoroglycofen-ethyl, fomesafen, halosafen, lactofen, oxyfluorfen, pyraflufen-ethyl, saflufenacil, sulfentrazone, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione and other agriculturally acceptable salts thereof; and
B) at least one fungicide B selected from bixafen, boscalid, fluxapyroxad, isopyrazam, penflufen, sedaxane, and 3-difluoromethyl-1-methyl-1H-pyrazole-4-carboxylic acid (9-dichloromethylene-1,2,3,4-tetrahydro-1,4-methano-naphthalen-5-yl)-amide.

According to a preferred embodiment of the invention, the composition comprises as component A at least one, preferably exactly one, PPO inhibitor A.

According to another preferred embodiment of the invention, the composition comprises as component A at least two, preferably exactly two, PPO inhibitors A different from each other.

According to another preferred embodiment of the invention, the composition comprises as component A at least three, preferably exactly three, PPO inhibitors A different from each other.

According to another preferred embodiment of the invention, the composition comprises as component B at least one, preferably exactly one, respiration inhibitor B.

According to another preferred embodiment of the invention, the composition comprises as component B at least two, preferably exactly two, respiration inhibitors B different from each other.

According to another preferred embodiment of the invention, the composition comprises as component A at least one, preferably exactly one, PPO inhibitor A, and at least one, preferably exactly one, respiration inhibitor B.

According to another preferred embodiment of the invention, the composition comprises as component A at least two, preferably exactly two, PPO inhibitors A different from each other, and at least one, preferably exactly one, respiration inhibitor B.

According to another preferred embodiment of the invention, the composition comprises as component A at least three, preferably exactly three, PPO inhibitors A different from each other, and at least one, preferably exactly one, respiration inhibitor B.

According to another preferred embodiment of the invention, the composition comprises as only active components at least one, preferably exactly one, PPO inhibitor A, and at least one, preferably exactly one, respiration inhibitor B.

Particularly preferred are the compositions 1.1 to 1.666, comprising at least one PPO inhibitor A and at least one respiration inhibitor B, preferably comprising the PPO inhibitor A and the respiration inhibitor B, as defined in the respective row of table 1. The compound numbers (A.x for herbicide A; B.x for fungicide B) correspond to the compound numbers given above in the list of herbicides A and fungicides B according to the present invention.

TABLE 1
(compositions 1.1. to 1.666)

| No | herb. A | fung. B |
|---|---|---|
| 1.1 | A.1 | B.1 |
| 1.2 | A.1 | B.2 |
| 1.3 | A.1 | B.3 |
| 1.4 | A.1 | B.4 |
| 1.5 | A.1 | B.5 |
| 1.6 | A.1 | B.6 |
| 1.7 | A.1 | B.7 |
| 1.8 | A.1 | B.8 |
| 1.9 | A.1 | B.9 |
| 1.10 | A.1 | B.10 |
| 1.11 | A.1 | B.11 |
| 1.12 | A.1 | B.12 |
| 1.13 | A.1 | B.13 |
| 1.14 | A.1 | B.14 |
| 1.15 | A.1 | B.15 |
| 1.16 | A.1 | B.16 |
| 1.17 | A.1 | B.17 |
| 1.18 | A.1 | B.18 |
| 1.19 | A.2 | B.1 |
| 1.20 | A.2 | B.2 |
| 1.21 | A.2 | B.3 |
| 1.22 | A.2 | B.4 |
| 1.23 | A.2 | B.5 |
| 1.24 | A.2 | B.6 |
| 1.25 | A.2 | B.7 |
| 1.26 | A.2 | B.8 |
| 1.27 | A.2 | B.9 |
| 1.28 | A.2 | B.10 |
| 1.29 | A.2 | B.11 |
| 1.30 | A.2 | B.12 |
| 1.31 | A.2 | B.13 |
| 1.32 | A.2 | B.14 |
| 1.33 | A.2 | B.15 |
| 1.34 | A.2 | B.16 |
| 1.35 | A.2 | B.17 |
| 1.36 | A.2 | B.18 |
| 1.37 | A.3 | B.1 |
| 1.38 | A.3 | B.2 |
| 1.39 | A.3 | B.3 |
| 1.40 | A.3 | B.4 |
| 1.41 | A.3 | B.5 |
| 1.42 | A.3 | B.6 |
| 1.43 | A.3 | B.7 |
| 1.44 | A.3 | B.8 |
| 1.45 | A.3 | B.9 |
| 1.46 | A.3 | B.10 |
| 1.47 | A.3 | B.11 |
| 1.48 | A.3 | B.12 |
| 1.49 | A.3 | B.13 |
| 1.50 | A.3 | B.14 |
| 1.51 | A.3 | B.15 |
| 1.52 | A.3 | B.16 |
| 1.53 | A.3 | B.17 |
| 1.54 | A.3 | B.18 |
| 1.55 | A.4 | B.1 |
| 1.56 | A.4 | B.2 |
| 1.57 | A.4 | B.3 |
| 1.58 | A.4 | B.4 |
| 1.59 | A.4 | B.5 |
| 1.60 | A.4 | B.6 |
| 1.61 | A.4 | B.7 |
| 1.62 | A.4 | B.8 |
| 1.63 | A.4 | B.9 |
| 1.64 | A.4 | B.10 |
| 1.65 | A.4 | B.11 |
| 1.66 | A.4 | B.12 |
| 1.67 | A.4 | B.13 |
| 1.68 | A.4 | B.14 |
| 1.69 | A.4 | B.15 |
| 1.70 | A.4 | B.16 |
| 1.71 | A.4 | B.17 |
| 1.72 | A.4 | B.18 |
| 1.73 | A.5 | B.1 |
| 1.74 | A.5 | B.2 |
| 1.75 | A.5 | B.3 |
| 1.76 | A.5 | B.4 |
| 1.77 | A.5 | B.5 |
| 1.78 | A.5 | B.6 |
| 1.79 | A.5 | B.7 |
| 1.80 | A.5 | B.8 |
| 1.81 | A.5 | B.9 |
| 1.82 | A.5 | B.10 |
| 1.83 | A.5 | B.11 |
| 1.84 | A.5 | B.12 |
| 1.85 | A.5 | B.13 |
| 1.86 | A.5 | B.14 |
| 1.87 | A.5 | B.15 |
| 1.88 | A.5 | B.16 |
| 1.89 | A.5 | B.17 |
| 1.90 | A.5 | B.18 |
| 1.91 | A.6 | B.1 |
| 1.92 | A.6 | B.2 |
| 1.93 | A.6 | B.3 |
| 1.94 | A.6 | B.4 |
| 1.95 | A.6 | B.5 |
| 1.96 | A.6 | B.6 |
| 1.97 | A.6 | B.7 |
| 1.98 | A.6 | B.8 |
| 1.99 | A.6 | B.9 |
| 1.100 | A.6 | B.10 |
| 1.101 | A.6 | B.11 |
| 1.102 | A.6 | B.12 |
| 1.103 | A.6 | B.13 |
| 1.104 | A.6 | B.14 |
| 1.105 | A.6 | B.15 |
| 1.106 | A.6 | B.16 |
| 1.107 | A.6 | B.17 |
| 1.108 | A.6 | B.18 |
| 1.109 | A.7 | B.1 |
| 1.110 | A.7 | B.2 |
| 1.111 | A.7 | B.3 |
| 1.112 | A.7 | B.4 |
| 1.113 | A.7 | B.5 |
| 1.114 | A.7 | B.6 |
| 1.115 | A.7 | B.7 |
| 1.116 | A.7 | B.8 |
| 1.117 | A.7 | B.9 |
| 1.118 | A.7 | B.10 |
| 1.119 | A.7 | B.11 |
| 1.120 | A.7 | B.12 |
| 1.121 | A.7 | B.13 |
| 1.122 | A.7 | B.14 |
| 1.123 | A.7 | B.15 |
| 1.124 | A.7 | B.16 |
| 1.125 | A.7 | B.17 |
| 1.126 | A.7 | B.18 |
| 1.127 | A.8 | B.1 |
| 1.128 | A.8 | B.2 |
| 1.129 | A.8 | B.3 |
| 1.130 | A.8 | B.4 |
| 1.131 | A.8 | B.5 |
| 1.132 | A.8 | B.6 |
| 1.133 | A.8 | B.7 |
| 1.134 | A.8 | B.8 |
| 1.135 | A.8 | B.9 |
| 1.136 | A.8 | B.10 |
| 1.137 | A.8 | B.11 |
| 1.138 | A.8 | B.12 |
| 1.139 | A.8 | B.13 |
| 1.140 | A.8 | B.14 |
| 1.141 | A.8 | B.15 |
| 1.142 | A.8 | B.16 |
| 1.143 | A.8 | B.17 |
| 1.144 | A.8 | B.18 |
| 1.145 | A.9 | B.1 |
| 1.146 | A.9 | B.2 |
| 1.147 | A.9 | B.3 |
| 1.148 | A.9 | B.4 |
| 1.149 | A.9 | B.5 |
| 1.150 | A.9 | B.6 |
| 1.151 | A.9 | B.7 |
| 1.152 | A.9 | B.8 |
| 1.153 | A.9 | B.9 |
| 1.154 | A.9 | B.10 |
| 1.155 | A.9 | B.11 |
| 1.156 | A.9 | B.12 |
| 1.157 | A.9 | B.13 |
| 1.158 | A.9 | B.14 |
| 1.159 | A.9 | B.15 |
| 1.160 | A.9 | B.16 |
| 1.161 | A.9 | B.17 |
| 1.162 | A.9 | B.18 |
| 1.163 | A.10 | B.1 |
| 1.164 | A.10 | B.2 |
| 1.165 | A.10 | B.3 |
| 1.166 | A.10 | B.4 |
| 1.167 | A.10 | B.5 |
| 1.168 | A.10 | B.6 |
| 1.169 | A.10 | B.7 |
| 1.170 | A.10 | B.8 |
| 1.171 | A.10 | B.9 |
| 1.172 | A.10 | B.10 |
| 1.173 | A.10 | B.11 |
| 1.174 | A.10 | B.12 |
| 1.175 | A.10 | B.13 |
| 1.176 | A.10 | B.14 |
| 1.177 | A.10 | B.15 |
| 1.178 | A.10 | B.16 |
| 1.179 | A.10 | B.17 |
| 1.180 | A.10 | B.18 |
| 1.181 | A.11 | B.1 |
| 1.182 | A.11 | B.2 |
| 1.183 | A.11 | B.3 |
| 1.184 | A.11 | B.4 |
| 1.185 | A.11 | B.5 |
| 1.186 | A.11 | B.6 |
| 1.187 | A.11 | B.7 |
| 1.188 | A.11 | B.8 |
| 1.189 | A.11 | B.9 |
| 1.190 | A.11 | B.10 |
| 1.191 | A.11 | B.11 |
| 1.192 | A.11 | B.12 |
| 1.193 | A.11 | B.13 |
| 1.194 | A.11 | B.14 |
| 1.195 | A.11 | B.15 |
| 1.196 | A.11 | B.16 |
| 1.197 | A.11 | B.17 |
| 1.198 | A.11 | B.18 |
| 1.199 | A.12 | B.1 |
| 1.200 | A.12 | B.2 |
| 1.201 | A.12 | B.3 |
| 1.202 | A.12 | B.4 |
| 1.203 | A.12 | B.5 |
| 1.204 | A.12 | B.6 |
| 1.205 | A.12 | B.7 |
| 1.206 | A.12 | B.8 |
| 1.207 | A.12 | B.9 |
| 1.208 | A.12 | B.10 |
| 1.209 | A.12 | B.11 |
| 1.210 | A.12 | B.12 |
| 1.211 | A.12 | B.13 |
| 1.212 | A.12 | B.14 |
| 1.213 | A.12 | B.15 |
| 1.214 | A.12 | B.16 |
| 1.215 | A.12 | B.17 |
| 1.216 | A.12 | B.18 |
| 1.217 | A.13 | B.1 |
| 1.218 | A.13 | B.2 |
| 1.219 | A.13 | B.3 |
| 1.220 | A.13 | B.4 |
| 1.221 | A.13 | B.5 |
| 1.222 | A.13 | B.6 |
| 1.223 | A.13 | B.7 |
| 1.224 | A.13 | B.8 |
| 1.225 | A.13 | B.9 |
| 1.226 | A.13 | B.10 |
| 1.227 | A.13 | B.11 |
| 1.228 | A.13 | B.12 |
| 1.229 | A.13 | B.13 |
| 1.230 | A.13 | B.14 |
| 1.231 | A.13 | B.15 |
| 1.232 | A.13 | B.16 |
| 1.233 | A.13 | B.17 |
| 1.234 | A.13 | B.18 |
| 1.235 | A.14 | B.1 |
| 1.236 | A.14 | B.2 |
| 1.237 | A.14 | B.3 |
| 1.238 | A.14 | B.4 |
| 1.239 | A.14 | B.5 |
| 1.240 | A.14 | B.6 |
| 1.241 | A.14 | B.7 |
| 1.242 | A.14 | B.8 |
| 1.243 | A.14 | B.9 |
| 1.244 | A.14 | B.10 |
| 1.245 | A.14 | B.11 |
| 1.246 | A.14 | B.12 |
| 1.247 | A.14 | B.13 |
| 1.248 | A.14 | B.14 |
| 1.249 | A.14 | B.15 |
| 1.250 | A.14 | B.16 |
| 1.251 | A.14 | B.17 |
| 1.252 | A.14 | B.18 |
| 1.253 | A.15 | B.1 |
| 1.254 | A.15 | B.2 |
| 1.255 | A.15 | B.3 |
| 1.256 | A.15 | B.4 |
| 1.257 | A.15 | B.5 |
| 1.258 | A.15 | B.6 |
| 1.259 | A.15 | B.7 |
| 1.260 | A.15 | B.8 |
| 1.261 | A.15 | B.9 |
| 1.262 | A.15 | B.10 |
| 1.263 | A.15 | B.11 |
| 1.264 | A.15 | B.12 |
| 1.265 | A.15 | B.13 |
| 1.266 | A.15 | B.14 |
| 1.267 | A.15 | B.15 |
| 1.268 | A.15 | B.16 |
| 1.269 | A.15 | B.17 |
| 1.270 | A.15 | B.18 |
| 1.271 | A.16 | B.1 |
| 1.272 | A.16 | B.2 |
| 1.273 | A.16 | B.3 |
| 1.274 | A.16 | B.4 |
| 1.275 | A.16 | B.5 |
| 1.276 | A.16 | B.6 |
| 1.277 | A.16 | B.7 |
| 1.278 | A.16 | B.8 |
| 1.279 | A.16 | B.9 |
| 1.280 | A.16 | B.10 |
| 1.281 | A.16 | B.11 |
| 1.282 | A.16 | B.12 |
| 1.283 | A.16 | B.13 |
| 1.284 | A.16 | B.14 |
| 1.285 | A.16 | B.15 |
| 1.286 | A.16 | B.16 |
| 1.287 | A.16 | B.17 |
| 1.288 | A.16 | B.18 |
| 1.289 | A.17 | B.1 |
| 1.290 | A.17 | B.2 |
| 1.291 | A.17 | B.3 |
| 1.292 | A.17 | B.4 |
| 1.293 | A.17 | B.5 |
| 1.294 | A.17 | B.6 |
| 1.295 | A.17 | B.7 |
| 1.296 | A.17 | B.8 |
| 1.297 | A.17 | B.9 |
| 1.298 | A.17 | B.10 |
| 1.299 | A.17 | B.11 |
| 1.300 | A.17 | B.12 |
| 1.301 | A.17 | B.13 |
| 1.302 | A.17 | B.14 |
| 1.303 | A.17 | B.15 |
| 1.304 | A.17 | B.16 |
| 1.305 | A.17 | B.17 |
| 1.306 | A.17 | B.18 |
| 1.307 | A.18 | B.1 |
| 1.308 | A.18 | B.2 |
| 1.309 | A.18 | B.3 |
| 1.310 | A.18 | B.4 |
| 1.311 | A.18 | B.5 |
| 1.312 | A.18 | B.6 |
| 1.313 | A.18 | B.7 |
| 1.314 | A.18 | B.8 |
| 1.315 | A.18 | B.9 |
| 1.316 | A.18 | B.10 |
| 1.317 | A.18 | B.11 |
| 1.318 | A.18 | B.12 |
| 1.319 | A.18 | B.13 |
| 1.320 | A.18 | B.14 |
| 1.321 | A.18 | B.15 |
| 1.322 | A.18 | B.16 |
| 1.323 | A.18 | B.17 |
| 1.324 | A.18 | B.18 |
| 1.325 | A.19 | B.1 |
| 1.326 | A.19 | B.2 |
| 1.327 | A.19 | B.3 |
| 1.328 | A.19 | B.4 |
| 1.329 | A.19 | B.5 |
| 1.330 | A.19 | B.6 |
| 1.331 | A.19 | B.7 |
| 1.332 | A.19 | B.8 |
| 1.333 | A.19 | B.9 |
| 1.334 | A.19 | B.10 |
| 1.335 | A.19 | B.11 |
| 1.336 | A.19 | B.12 |
| 1.337 | A.19 | B.13 |
| 1.338 | A.19 | B.14 |
| 1.339 | A.19 | B.15 |
| 1.340 | A.19 | B.16 |
| 1.341 | A.19 | B.17 |
| 1.342 | A.19 | B.18 |
| 1.343 | A.20 | B.1 |
| 1.344 | A.20 | B.2 |
| 1.345 | A.20 | B.3 |
| 1.346 | A.20 | B.4 |
| 1.347 | A.20 | B.5 |
| 1.348 | A.20 | B.6 |
| 1.349 | A.20 | B.7 |
| 1.350 | A.20 | B.8 |
| 1.351 | A.20 | B.9 |
| 1.352 | A.20 | B.10 |
| 1.353 | A.20 | B.11 |
| 1.354 | A.20 | B.12 |
| 1.355 | A.20 | B.13 |
| 1.356 | A.20 | B.14 |
| 1.357 | A.20 | B.15 |
| 1.358 | A.20 | B.16 |
| 1.359 | A.20 | B.17 |
| 1.360 | A.20 | B.18 |
| 1.361 | A.21 | B.1 |
| 1.362 | A.21 | B.2 |
| 1.363 | A.21 | B.3 |
| 1.364 | A.21 | B.4 |
| 1.365 | A.21 | B.5 |
| 1.366 | A.21 | B.6 |
| 1.367 | A.21 | B.7 |
| 1.368 | A.21 | B.8 |
| 1.369 | A.21 | B.9 |
| 1.370 | A.21 | B.10 |
| 1.371 | A.21 | B.11 |
| 1.372 | A.21 | B.12 |
| 1.373 | A.21 | B.13 |
| 1.374 | A.21 | B.14 |
| 1.375 | A.21 | B.15 |
| 1.376 | A.21 | B.16 |
| 1.377 | A.21 | B.17 |
| 1.378 | A.21 | B.18 |
| 1.379 | A.22 | B.1 |
| 1.380 | A.22 | B.2 |
| 1.381 | A.22 | B.3 |
| 1.382 | A.22 | B.4 |
| 1.383 | A.22 | B.5 |
| 1.384 | A.22 | B.6 |
| 1.385 | A.22 | B.7 |
| 1.386 | A.22 | B.8 |
| 1.387 | A.22 | B.9 |
| 1.388 | A.22 | B.10 |
| 1.389 | A.22 | B.11 |
| 1.390 | A.22 | B.12 |
| 1.391 | A.22 | B.13 |
| 1.392 | A.22 | B.14 |
| 1.393 | A.22 | B.15 |
| 1.394 | A.22 | B.16 |
| 1.395 | A.22 | B.17 |
| 1.396 | A.22 | B.18 |
| 1.397 | A.23 | B.1 |
| 1.398 | A.23 | B.2 |
| 1.399 | A.23 | B.3 |
| 1.400 | A.23 | B.4 |
| 1.401 | A.23 | B.5 |
| 1.402 | A.23 | B.6 |
| 1.403 | A.23 | B.7 |
| 1.404 | A.23 | B.8 |
| 1.405 | A.23 | B.9 |
| 1.406 | A.23 | B.10 |
| 1.407 | A.23 | B.11 |
| 1.408 | A.23 | B.12 |
| 1.409 | A.23 | B.13 |
| 1.410 | A.23 | B.14 |
| 1.411 | A.23 | B.15 |
| 1.412 | A.23 | B.16 |
| 1.413 | A.23 | B.17 |
| 1.414 | A.23 | B.18 |
| 1.415 | A.24 | B.1 |
| 1.416 | A.24 | B.2 |
| 1.417 | A.24 | B.3 |
| 1.418 | A.24 | B.4 |
| 1.419 | A.24 | B.5 |
| 1.420 | A.24 | B.6 |
| 1.421 | A.24 | B.7 |
| 1.422 | A.24 | B.8 |
| 1.423 | A.24 | B.9 |
| 1.424 | A.24 | B.10 |
| 1.425 | A.24 | B.11 |
| 1.426 | A.24 | B.12 |
| 1.427 | A.24 | B.13 |
| 1.428 | A.24 | B.14 |
| 1.429 | A.24 | B.15 |
| 1.430 | A.24 | B.16 |
| 1.431 | A.24 | B.17 |
| 1.432 | A.24 | B.18 |
| 1.433 | A.25 | B.1 |
| 1.434 | A.25 | B.2 |
| 1.435 | A.25 | B.3 |
| 1.436 | A.25 | B.4 |
| 1.437 | A.25 | B.5 |
| 1.438 | A.25 | B.6 |
| 1.439 | A.25 | B.7 |
| 1.440 | A.25 | B.8 |
| 1.441 | A.25 | B.9 |
| 1.442 | A.25 | B.10 |
| 1.443 | A.25 | B.11 |
| 1.444 | A.25 | B.12 |
| 1.445 | A.25 | B.13 |
| 1.446 | A.25 | B.14 |
| 1.447 | A.25 | B.15 |
| 1.448 | A.25 | B.16 |
| 1.449 | A.25 | B.17 |
| 1.450 | A.25 | B.18 |
| 1.451 | A.26 | B.1 |
| 1.452 | A.26 | B.2 |
| 1.453 | A.26 | B.3 |
| 1.454 | A.26 | B.4 |
| 1.455 | A.26 | B.5 |
| 1.456 | A.26 | B.6 |
| 1.457 | A.26 | B.7 |
| 1.458 | A.26 | B.8 |
| 1.459 | A.26 | B.9 |
| 1.460 | A.26 | B.10 |
| 1.461 | A.26 | B.11 |
| 1.462 | A.26 | B.12 |
| 1.463 | A.26 | B.13 |
| 1.464 | A.26 | B.14 |
| 1.465 | A.26 | B.15 |
| 1.466 | A.26 | B.16 |
| 1.467 | A.26 | B.17 |
| 1.468 | A.26 | B.18 |
| 1.469 | A.27 | B.1 |
| 1.470 | A.27 | B.2 |
| 1.471 | A.27 | B.3 |
| 1.472 | A.27 | B.4 |
| 1.473 | A.27 | B.5 |
| 1.474 | A.27 | B.6 |
| 1.475 | A.27 | B.7 |
| 1.476 | A.27 | B.8 |
| 1.477 | A.27 | B.9 |
| 1.478 | A.27 | B.10 |
| 1.479 | A.27 | B.11 |
| 1.480 | A.27 | B.12 |
| 1.481 | A.27 | B.13 |
| 1.482 | A.27 | B.14 |
| 1.483 | A.27 | B.15 |
| 1.484 | A.27 | B.16 |
| 1.485 | A.27 | B.17 |
| 1.486 | A.27 | B.18 |
| 1.487 | A.28 | B.1 |
| 1.488 | A.28 | B.2 |
| 1.489 | A.28 | B.3 |
| 1.490 | A.28 | B.4 |
| 1.491 | A.28 | B.5 |
| 1.492 | A.28 | B.6 |
| 1.493 | A.28 | B.7 |
| 1.494 | A.28 | B.8 |
| 1.495 | A.28 | B.9 |
| 1.496 | A.28 | B.10 |
| 1.497 | A.28 | B.11 |
| 1.498 | A.28 | B.12 |
| 1.499 | A.28 | B.13 |
| 1.500 | A.28 | B.14 |
| 1.501 | A.28 | B.15 |
| 1.502 | A.28 | B.16 |
| 1.503 | A.28 | B.17 |
| 1.504 | A.28 | B.18 |
| 1.505 | A.29 | B.1 |
| 1.506 | A.29 | B.2 |
| 1.507 | A.29 | B.3 |
| 1.508 | A.29 | B.4 |
| 1.509 | A.29 | B.5 |
| 1.510 | A.29 | B.6 |
| 1.511 | A.29 | B.7 |
| 1.512 | A.29 | B.8 |
| 1.513 | A.29 | B.9 |
| 1.514 | A.29 | B.10 |
| 1.515 | A.29 | B.11 |
| 1.516 | A.29 | B.12 |
| 1.517 | A.29 | B.13 |
| 1.518 | A.29 | B.14 |
| 1.519 | A.29 | B.15 |
| 1.520 | A.29 | B.16 |
| 1.521 | A.29 | B.17 |
| 1.522 | A.29 | B.18 |
| 1.523 | A.30 | B.1 |
| 1.524 | A.30 | B.2 |
| 1.525 | A.30 | B.3 |
| 1.526 | A.30 | B.4 |
| 1.527 | A.30 | B.5 |
| 1.528 | A.30 | B.6 |
| 1.529 | A.30 | B.7 |
| 1.530 | A.30 | B.8 |
| 1.531 | A.30 | B.9 |
| 1.532 | A.30 | B.10 |
| 1.533 | A.30 | B.11 |
| 1.534 | A.30 | B.12 |
| 1.535 | A.30 | B.13 |
| 1.536 | A.30 | B.14 |
| 1.537 | A.30 | B.15 |
| 1.538 | A.30 | B.16 |
| 1.539 | A.30 | B.17 |
| 1.540 | A.30 | B.18 |
| 1.541 | A.31 | B.1 |
| 1.542 | A.31 | B.2 |
| 1.543 | A.31 | B.3 |
| 1.544 | A.31 | B.4 |
| 1.545 | A.31 | B.5 |
| 1.546 | A.31 | B.6 |
| 1.547 | A.31 | B.7 |
| 1.548 | A.31 | B.8 |
| 1.549 | A.31 | B.9 |
| 1.550 | A.31 | B.10 |
| 1.551 | A.31 | B.11 |
| 1.552 | A.31 | B.12 |
| 1.553 | A.31 | B.13 |
| 1.554 | A.31 | B.14 |
| 1.555 | A.31 | B.15 |
| 1.556 | A.31 | B.16 |
| 1.557 | A.31 | B.17 |
| 1.558 | A.31 | B.18 |
| 1.559 | A.32 | B.1 |
| 1.560 | A.32 | B.2 |
| 1.561 | A.32 | B.3 |
| 1.562 | A.32 | B.4 |
| 1.563 | A.32 | B.5 |
| 1.564 | A.32 | B.6 |
| 1.565 | A.32 | B.7 |
| 1.566 | A.32 | B.8 |
| 1.567 | A.32 | B.9 |
| 1.568 | A.32 | B.10 |
| 1.569 | A.32 | B.11 |
| 1.570 | A.32 | B.12 |
| 1.571 | A.32 | B.13 |
| 1.572 | A.32 | B.14 |
| 1.573 | A.32 | B.15 |
| 1.574 | A.32 | B.16 |
| 1.575 | A.32 | B.17 |
| 1.576 | A.32 | B.18 |
| 1.577 | A.33 | B.1 |
| 1.578 | A.33 | B.2 |
| 1.579 | A.33 | B.3 |
| 1.580 | A.33 | B.4 |
| 1.581 | A.33 | B.5 |
| 1.582 | A.33 | B.6 |
| 1.583 | A.33 | B.7 |
| 1.584 | A.33 | B.8 |
| 1.585 | A.33 | B.9 |
| 1.586 | A.33 | B.10 |
| 1.587 | A.33 | B.11 |
| 1.588 | A.33 | B.12 |
| 1.589 | A.33 | B.13 |
| 1.590 | A.33 | B.14 |
| 1.591 | A.33 | B.15 |
| 1.592 | A.33 | B.16 |
| 1.593 | A.33 | B.17 |
| 1.594 | A.33 | B.18 |
| 1.595 | A.34 | B.1 |
| 1.596 | A.34 | B.2 |
| 1.597 | A.34 | B.3 |
| 1.598 | A.34 | B.4 |
| 1.599 | A.34 | B.5 |
| 1.600 | A.34 | B.6 |
| 1.601 | A.34 | B.7 |
| 1.602 | A.34 | B.8 |
| 1.603 | A.34 | B.9 |
| 1.604 | A.34 | B.10 |
| 1.605 | A.34 | B.11 |
| 1.606 | A.34 | B.12 |
| 1.607 | A.34 | B.13 |
| 1.608 | A.34 | B.14 |
| 1.609 | A.34 | B.15 |
| 1.610 | A.34 | B.16 |
| 1.611 | A.34 | B.17 |
| 1.612 | A.34 | B.18 |
| 1.613 | A.35 | B.1 |
| 1.614 | A.35 | B.2 |
| 1.615 | A.35 | B.3 |
| 1.616 | A.35 | B.4 |
| 1.617 | A.35 | B.5 |
| 1.618 | A.35 | B.6 |
| 1.619 | A.35 | B.7 |
| 1.620 | A.35 | B.8 |
| 1.621 | A.35 | B.9 |
| 1.622 | A.35 | B.10 |
| 1.623 | A.35 | B.11 |
| 1.624 | A.35 | B.12 |
| 1.625 | A.35 | B.13 |
| 1.626 | A.35 | B.14 |
| 1.627 | A.35 | B.15 |
| 1.628 | A.35 | B.16 |
| 1.629 | A.35 | B.17 |
| 1.630 | A.35 | B.18 |
| 1.631 | A.36 | B.1 |
| 1.632 | A.36 | B.2 |
| 1.633 | A.36 | B.3 |
| 1.634 | A.36 | B.4 |
| 1.635 | A.36 | B.5 |
| 1.636 | A.36 | B.6 |
| 1.637 | A.36 | B.7 |
| 1.638 | A.36 | B.8 |
| 1.639 | A.36 | B.9 |
| 1.640 | A.36 | B.10 |
| 1.641 | A.36 | B.11 |
| 1.642 | A.36 | B.12 |
| 1.643 | A.36 | B.13 |
| 1.644 | A.36 | B.14 |
| 1.645 | A.36 | B.15 |
| 1.646 | A.36 | B.16 |
| 1.647 | A.36 | B.17 |
| 1.648 | A.36 | B.18 |
| 1.649 | A.37 | B.1 |
| 1.650 | A.37 | B.2 |
| 1.651 | A.37 | B.3 |
| 1.652 | A.37 | B.4 |
| 1.653 | A.37 | B.5 |
| 1.654 | A.37 | B.6 |
| 1.655 | A.37 | B.7 |
| 1.656 | A.37 | B.8 |
| 1.657 | A.37 | B.9 |
| 1.658 | A.37 | B.10 |
| 1.659 | A.37 | B.11 |
| 1.660 | A.37 | B.12 |
| 1.661 | A.37 | B.13 |
| 1.662 | A.37 | B.14 |
| 1.663 | A.37 | B.15 |
| 1.664 | A.37 | B.16 |
| 1.665 | A.37 | B.17 |
| 1.666 | A.37 | B.18 |

Among the above compositions, preference is given to following combinations:

1.2, 1.3, 1.6, 1.8, 1.10, 1.13, 1.14, 1.15, 1.17, 1.18,

1.38, 1.39, 1.42, 1.44, 1.46, 1.49, 1.50, 1.51, 1.53, 1.54,

1.74, 1.75, 1.78, 1.80, 1.82, 1.85, 1.86, 1.87, 1.89, 1.90,

1.110, 1.111, 1.114, 1.116, 1.118, 1.121, 1.122, 1.123, 1.125, 1.126,

1.146, 1.147, 1.150, 1.152, 1.154, 1.157, 1.158, 1.159, 1.161, 1.162,

1.200, 1.201, 1.204, 1.206, 1.208, 1.211, 1.212, 1.213, 1.215, 1.216,

1.218, 1.219, 1.222, 1.224, 1.226, 1.229, 1.230, 1.231, 1.233, 1.234,

1.236, 1.237, 1.240, 1.242, 1.244, 1.247, 1.248, 1.249, 1.251, 1.252,

1.254, 1.255, 1.258, 1.260, 1.262, 1.265, 1.266, 1.267, 1.268, 1.270,

1.272, 1.273, 1.276, 1.278, 1.280, 1.283, 1.284, 1.285, 1.287, 1.288,

1.290, 1.291, 1.294, 1.296, 1.298, 1.301, 1.302, 1.303, 1.305, 1.306,

1.308, 1.309, 1.312, 1.314, 1.316, 1.319, 1.320, 1.321, 1.323, 1.324,

1.326, 1.327, 1.330, 1.332, 1.334, 1.337, 1.338, 1.339, 1.341, 1.342,

1.344, 1.345, 1.348, 1.350, 1.352, 1.355, 1.356, 1.357, 1.359, 1.360,

1.362, 1.363, 1.366, 1.368, 1.370, 1.373, 1.374, 1.375, 1.377, 1.378,

1.380, 1.381, 1.384, 1.386, 1.388, 1.391, 1.392, 1.393, 1.395, 1.396,

1.398, 1.399, 1.402, 1.404, 1.406, 1.409, 1.410, 1.411, 1.413, 1.414,

1.434, 1.435, 1.438, 1.440, 1.442, 1.445, 1.446, 1.447, 1.449, 1.450,

1.452, 1.453, 1.456, 1.458, 1.460, 1.463, 1.464, 1.465, 1.467, 1.468,

1.470, 1.471, 1.474, 1.476, 1.478, 1.481, 1.482, 1.483, 1.485, 1.486,

1.488, 1.489, 1.492, 1.494, 1.496, 1.499, 1.500, 1.501, 1.503, 1.504,

1.524, 1.525, 1.528, 1.530, 1.532, 1.535, 1.536, 1.537, 1.539, 1.540,

1.650, 1.651, 1.654, 1.656, 1.658, 1.661, 1.662, 1.663, 1.665, 1.666.

More preference is given to following compositions:

1.2, 1.3, 1.8, 1.10, 1.14, 1.15, 1.17,

1.38, 1.39, 1.44, 1.46, 1.50, 1.51, 1.53,

1.110, 1.111, 1.116, 1.118, 1.122, 1.123, 1.125,

1.146, 1.147, 1.152, 1.154, 1.158, 1.159, 1.161,

1.200, 1.201, 1.206, 1.208, 1.212, 1.213, 1.215,

1.218, 1.219, 1.224, 1.226, 1.230, 1.231, 1.233,

1.236, 1.237, 1.242, 1.244, 1.248, 1.249, 1.251,

1.254, 1.255, 1.260, 1.262, 1.266, 1.267, 1.268,

1.290, 1.291, 1.296, 1.298, 1.302, 1.303, 1.305,

1.308, 1.309, 1.314, 1.316, 1.320, 1.321, 1.323,

1.326, 1.327, 1.332, 1.334, 1.338, 1.339, 1.341,

1.380, 1.381, 1.386, 1.388, 1.392, 1.393, 1.395,

1.452, 1.453, 1.458, 1.460, 1.464, 1.465, 1.467,

1.470, 1.471, 1.476, 1.478, 1.482, 1.483, 1.485,

1.488, 1.489, 1.494, 1.496, 1.500, 1.501, 1.503,

1.524, 1.525, 1.530, 1.532, 1.536, 1.537, 1.539,

1.650, 1.651, 1.656, 1.658, 1.662, 1.663, 1.665.

It may furthermore be beneficial to apply the compositions according to the present invention comprising the at least one the PPO inhibitor and at least one respiration inhibitor B in the form of a mixture with other crop protection agents, for example together with agents for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

It may be moreover useful to apply the compositions according to the present invention comprising at least one the herbicide A and the at least one fungicide B in combination with safeners. Accordingly in another embodiment of the present invention the compositions according to the present invention comprise as additional component at least one safener C.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The at least one safener C and at least one the herbicide A and at least one fungicide B can be applied simultaneously or in succession.

Suitable safeners C are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diary)-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Especially preferred safeners C are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)-amino]benzenesulfonamide (CAS 129531-12-0).

Particularly preferred safeners C are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

The safeners C are known safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998.

The assignment of the active compounds to the respective mechanisms of action is based on current knowledge. If several mechanisms of action apply to one active compound, this substance was only assigned to one mechanism of action.

If the PPO inhibitors A, the respiration inhibitor B and the optional safener C are capable of forming geometrical isomers, for example E/Z isomers, both the pure isomers and mixtures thereof may be used in the compositions according to the invention. If the PPO inhibitors A and/or the respiration inhibitor B have one of more centers of chirality and are thus present as enantiomers or diastereomers, both the pure enantiomers and diastereomers and mixtures thereof may be used in the compositions according to the invention.

The PPO inhibitors A, the respiration inhibitor B and the optional safener C can be present in different crystal modifications whose biological activity may differ. They are likewise subject matter of the present invention.

If the PPO inhibitors A, the respiration inhibitor B and the optional safener C have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyeth-1-oxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

The PPO inhibitors A, the respiration inhibitor B and the optional safener C having a carboxyl group can be employed in the form of the acid, in the form of an agriculturally suitable salt or else in the form of an agriculturally acceptable derivative in the compositions according to the invention, for example as amides, such as mono- and di-C₁-C₆-alkylamides or arylamides, as esters, for example as allyl esters, propargyl esters, C₁-C₁₀-alkyl esters, alkoxyalkyl esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxy ethyl esters, for example the methoxyethyl, ethoxyethyl or butoxyethyl ester. An example of a straight-chain or branched C₁-C₁₀-alkylthio ester is the ethylthio ester.

The compositions according to the present invention are useful in plant protection. The term “plant” generally comprises all plants of economic importance and/or men-grown plants. They are preferably selected from agricultural, silvicultural and ornamental plants, more preferably agricultural plants and silvicultural plants, utmost preferably agricultural plants. In this context, the term “plant (or plants)” is a synonym of the term “crop” which is to be understood as a plant of economic importance and/or a men-grown plant. Further the term “plant” as used herein includes all parts of a plant such as germinating seeds, emerging seedlings, herbaceous vegetation as well as established woody plants including all belowground portions (such as the roots) and above-ground portions.

The plants to be treated according to the invention are preferably selected from the group consisting of agricultural, silvicultural, ornamental and horticultural plants, each in its natural or genetically modified form, more preferably from agricultural plants.

The compositions according to the invention can also be used in genetically modified plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

Plants as well as the propagation material of said plants, which can be treated with the inventive mixtures include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, mixtures according to the present invention can be applied (as seed treatment, foliar spray treatment, in-furrow application or by any other means) also to plants which have been modified by breeding, mutagenesis or genetic engineering including but not limiting to agricultural biotech products on the market or in development (cf. http://www.bio.org/speeches/pubs/er/agri_products.asp).

Plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutgenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany). Preferably, the plant is tolerant against herbicides selected from the group consisting of protoporphyrinogen-IX oxidase (PPO) inhibitors, such as the above PPO inhibitors, photosynthetic electron transport inhibitors at the photosystem II receptor site, such as atrazine, bromoxynil or their agriculturally acceptable esters, acetylCoA carboxylase inhibitors (ACC inhibitors), acetolactate synthase inhibitors (ALS inhibitors), such as chlorimuron-ethyl, thifensulfuron-methyl, tribenuron-methyl, imazapyr, imazethapyr, imazapic, imazaquin, imazamox or their agriculturally acceptable salts, auxinic herbicides, such as 2,4-D, dicamba or their agriculturally acceptable salts, esters and amides, 4-hydroxyphenylpyruvate-dioxygenase (HPPD) inhibitors, such as benzobicyclone, bicyclopyrone, isoxaflutole, mesotrione, pyrasulfotole, sulcotrione, tefuryltrione, tembotrione, topramezone or their agriculturally acceptable salts, EPSP synthase inhibitors, such as glyphosate, sulfosate or their agriculturally acceptable salts and glutamine synthase inhibitors, such as glufosinate, bialafos or their agriculturally acceptable salts.

Furthermore, plants are also covered that are by the use of recombinant DNA techniques capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the CryIAb toxin), YieldGard® Plus (corn cultivars producing CryIAb and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the CryIAc toxin), Bollgard® I (cotton cultivars producing the CryIAc toxin), Bollgard® II (cotton cultivars producing CryIAc and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g., Agrisure® CB) and Bt176 from Syngenta Seeds SAS, France, (corn cultivars producing the CryIAb toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the CryIAc toxin) and 1507 from Pioneer Overseas Corporation, Belgium (corn cultivars producing the CryIF toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato cultivars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above.

Furthermore, plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of ingredients or new ingredients, specifically to improve human or animal nutrition, e.g., oil crops that produce health-promoting long-chain omega-3 fatty acids or unsaturated omega-9 fatty acids (e.g., Nexera® rape, Dow AgroSciences, Canada).

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

The compositions according to the invention or the crop protection compositions comprising them or formulated therefrom can be used, for example, in the form of ready-to-spray aqueous solutions, powders, suspensions, also highly concentrated aqueous, oily or other suspensions or dispersions, emulsions, oil dispersions, pastes, dusts, materials for broadcasting, or granules, by means of spraying, atomizing, dusting, broadcasting or watering or treatment of the seed or mixing with the seed. The use forms depend on the intended purpose; in any case, they should ensure the finest possible distribution of the active compounds according to the invention.

The crop protection compositions comprise an effective amount of the composition according to the invention, i.e. at least one PPO inhibitor A or an agriculturally useful salt thereof and at least one further active compound selected from the respiration inhibitor B, and also auxiliaries customary for formulating crop protection agents.

Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The crop protection compositions may also comprise auxiliaries which are customary in agrochemical compositions. The auxiliaries used depend on the particular application form and active substance, respectively.

Examples of auxiliaries customary for the formulation of crop protection agents are inert auxiliaries, solid or liquid carriers, surfactants (such as dispersants, protective colloids, emulsifiers, wetting agents and tackifiers), organic and inorganic thickeners, bactericides, antifreeze agents, antifoams, optionally colorants and, for seed formulations, adhesives.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on diclorophen and benzyl alcohol hemi-formal (Proxel® from ICI or Acticide® RS from Thor Chemie and Kathon® MK from Rohm & Haas), and also isothiazolinone derivates, such as alkylisothiazolinones and benzisothiazolinones (Acticide® MBS from Thor Chemie).

Examples of antifreeze agents are ethylene glycol, propylene glycol, urea or glycerol. Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives (tackifiers or binders) are polyvinylpyrrolidone, polyvinyl acetate, polyvinyl alcohol and cellulose ethers (Tylose®, shin-Etsu, Japan).

Suitable inert auxiliaries are, for example, the following: mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydronaphthalene, alkylated naphthalenes and their derivatives, alkylated benzenes and their derivatives, alcohols such as methanol, ethanol, propanol, butanol and cyclohexanol, ketones such as cyclohexanone or strongly polar solvents, for example amines such as N-methylpyrrolidone, and water.

Suitable carriers include liquid and solid carriers.

Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof.

Solid carriers include e.g. mineral earths such as silicas, silica gels, silicates, talc, kaolin, limestone, lime, chalk, bole, loess, clay, dolomite, diatomaceous earth, calcium sulfate, magnesium sulfate and magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

Powders, materials for broadcasting and dusts can be prepared by mixing or grinding the active ingredients together with a solid carrier.

Granules, for example coated granules, impregnated granules and homogeneous granules, can be prepared by binding the active ingredients to solid carriers.

Aqueous use forms can be prepared from emulsion concentrates, suspensions, pastes, wettable powders or water-dispersible granules by adding water. To prepare emulsions, pastes or oil dispersions, the components of the compositions according to the invention either as such or dissolved in an oil or solvent, can be homogenized in water by means of a wetting agent, tackifier, dispersant or emulsifier. Alternatively, it is also possible to prepare concentrates comprising active compound, wetting agent, tackifier, dispersant or emulsifier and, if desired, solvent or oil, which are suitable for dilution with water.

In the formulation of the compositions according to the present invention the active ingredients are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

The compositions of the invention can for example be formulated as follows:

1. Products for dilution with water

A Water-soluble concentrates (SL, LS)

10 parts by weight of active compound are dissolved in 90 parts by weight of water or a water-soluble solvent. As an alternative, wetters or other adjuvants are added. The active compound dissolves upon dilution with water. This gives a formulation with an active compound content of 10% by weight.

B Dispersible concentrates (DC)

20 parts by weight of active compound are dissolved in 70 parts by weight of cyclohexanone with addition of 10 parts by weight of a dispersant, for example polyvinylpyrrolidone. Dilution with water gives a dispersion. The active compound content is 20% by weight

C Emulsifiable concentrates (EC)

15 parts by weight of active compound are dissolved in 75 parts by weight of an organic solvent (eg. alkylaromatics) with addition of calcium dodecylbenzenesulfonate and castor oil ethoxylate (in each case 5 parts by weight). Dilution with water gives an emulsion. The formulation has an active compound content of 15% by weight.

D Emulsions (EW, EO, ES)

25 parts by weight of active compound are dissolved in 35 parts by weight of an organic solvent (eg. alkylaromatics) with addition of calcium dodecylbenzenesulfonate and castor oil ethoxylate (in each case 5 parts by weight). This mixture is introduced into 30 parts by weight of water by means of an emulsifier (e.g. Ultraturrax) and made into a homogeneous emulsion. Dilution with water gives an emulsion. The formulation has an active compound content of 25% by weight.

E Suspensions (SC, OD, FS)

In an agitated ball mill, 20 parts by weight of active compound are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-dispersible granules and water-soluble granules (WG, SG)

50 parts by weight of active compound are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

G Water-dispersible powders and water-soluble powders (WP, SP, SS, WS)

75 parts by weight of active compound are ground in a rotor-stator mill with addition of 25 parts by weight of dispersants, wetters and silica gel. Dilution with water gives a stable dispersion or solution of the active compound. The active compound content of the formulation is 75% by weight.

H Gel formulations (GF)

In a ball mill, 20 parts by weight of active compound, 10 parts by weight of dispersant, 1 part by weight of gelling agent and 70 parts by weight of water or of an organic solvent are mixed to give a fine suspension. Dilution with water gives a stable suspension with active compound content of 20% by weight.

2. Products to be applied undiluted

I Dusts (DP, DS)

5 parts by weight of active compound are ground finely and mixed intimately with 95 parts by weight of finely divided kaolin. This gives a dusting powder with an active compound content of 5% by weight.

J Granules (GR, FG, GG, MG)

0.5 parts by weight of active compound are ground finely and associated with 99.5 parts by weight of carriers. Current methods here are extrusion, spray-drying or the fluidized bed. This gives granules to be applied undiluted with an active compound content of 0.5% by weight.

K ULV solutions (UL)

10 parts by weight of active compound are dissolved in 90 parts by weight of an organic solvent, for example xylene. This gives a product to be applied undiluted with an active compound content of 10% by weight.

The concentrations of the active compounds in the ready-to-use preparations can be varied within wide ranges. In general, the formulations comprise from 0.001 to 98% by weight, preferably 0.01 to 95% by weight of at least one active compound. The active compounds are employed in a purity of from 90% to 100%, preferably 95% to 100% (according to NMR spectrum).

In the ready-to-use preparations, i.e. in the compositions according to the invention in the form of crop protection compositions, the components A and B can be present formutated jointly or separately in suspended, emulsified or dissolved form. The use forms depend entirely on the intended applications.

A first embodiment of the invention relates to compositions in the form of a crop protection composition formulated as a 1-component composition comprising the at least one active component A, at least one further active component B and optionally a safener C, and also a solid or liquid carrier and/or and, one or more surfactants, and, if desired, one or more further auxiliaries customary for crop protection compositions.

A second embodiment of the invention relates to compositions in the form of a crop protection composition formulated as a 2-component composition comprising a first formulation (component) comprising the at least one active component A, a solid or liquid carrier and, if appropriate, one or more surfactants, and a second component comprising at least one further active component B, and optionally a safener C, and a solid or liquid carrier and, if appropriate, and/or one or more surfactants, where additionally both components may also comprise further auxiliaries customary for crop protection compositions.

The compositions according to the invention are suitable as herbicides. They are suitable as such or as an appropriately formulated composition. The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Depending on the application method in question, the compositions according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, cotton, potatoes, peanuts or permanent crops.

Furthermore, it has been found that the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

In this method, it is of no importance whether the active compounds of components A and B are formulated and applied jointly or separately and in which order application is carried out in the case of separate application.

In crop protection products, it is desirable in principle to increase the specificity and the reliability of the action of active compounds. In particular, it is desirable for the crop protection product to control the harmful plants effectively and, at the same time, to be tolerated by the useful plants in question. It is known that in some cases better crop plant compatibility can be achieved by joint application of specifically acting herbicides with organic active compounds, which act as antidotes or antagonists. Owing to the fact that they can reduce or even prevent damage to the crop plants, they are also referred to as safeners.

It is therefore a further object of the present invention to provide herbicidal compositions, which are highly active against unwanted harmful plants, and, at the same time, the compositions should have good compatibility with useful plants. In addition, the compositions according to the invention should have a broad spectrum of activity.

This object is also achieved by the herbicidal active compositions comprising at least one PPO inhibitor as defined herein and at least one respiration inhibitor as defined herein.

The components A and B can be formulated and applied jointly or separately, simultaneously or in succession, before, during or after the emergence of the plants. In case of separate application, the order of the application of the components A and B is of minor importance. The only thing that is important is that the at least one active components A and B are present simultaneously at the site of action, i.e. are at the same time in contact with or taken up by the plant to be controlled and/or safened.

The crop protection compositions comprise an herbicidal effective amount of the composition according to the invention, i.e. at least one PPO inhibitor A or an agriculturally useful salt thereof and at least one further active compound selected from the respiration inhibitor B, and also auxiliaries customary for formulating crop protection agents as defined herein.

The required application rate of pure active compound composition, i.e. A and B and, if appropriate, C without formulation auxiliaries depends on the composition of the plant stand, on the development stage of the plants, on the climatic conditions at the site of use and on the application technique. In general, the application rate of A and B is from 0.001 to 3 kg/ha, preferably from 0.005 to 2.5 kg/ha and in particular from 0.01 to 2 kg/ha of active substance (a.s.).

The required application rates of the PPO inhibitor A are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of the optional safener C are generally in the range of from 0.0005 kg/ha to 2.5 kg/ha and preferably in the range of from 0.005 kg/ha to 2 kg/ha or 0.01 kg/ha to 1.5 kg/h of a.s.

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence or together with the seed of a crop plant. It is also possible to apply the compounds and compositions by applying seed, pretreated with a composition of the invention, of a crop plant. If the active compounds A and B and, if appropriate, C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula I according to the invention or the compositions prepared therefrom. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the compounds I are generally employed in amounts of from 0.001 to 10 kg per 100 kg of seed.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

The herbicidal effect of the compositions according to the present invention comprising at least a PPO inhibitor A and a respiration inhibitor B, and optionally one or more safeners C, on the growth of undesirable plants and the safening action on crops was demonstrated by the following greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly, and grown in the same containers, or they were first grown separately as seedlings and transplanted into the test containers a few days prior to treatment.

Depending on the species, the plants were kept at 10-25° C. and 20-35° C., respectively. The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. Good herbicidal activity is given at values of at least 70, and very good herbicidal activity is given at values of at least 85.

The respective stated components A and B, and if appropriate, C were formulated as a 10% by weight strength emulsion concentrate and, with addition of the amount of solvent system, introduced into the spray liquor used for applying the active compound. In the examples, the solvent used was water.

The test period extended over 20 and 21 days, respectively. During this time, the plants were tended, and their reaction to the treatment with active compound was monitored.

In the examples below, using the method of S. R. Colby (1967) “Calculating synergistic and antagonistic responses of herbicide combinations”, Weeds 15, p. 22ff., the value E, which is expected if the activity of the individual active compounds is only additive, was calculated.

E=X+Y−(X·Y/100)

where

X=percent activity using active compound A at an application rate a;

Y=percent activity using active compound B at an application rate b;

E=expected activity (in %) by A+B at application rates a+b.

If the value found experimentally is higher than the value E calculated according to Colby, a synergistic effect is present.

The compositions according to the invention are suitable as fungicides. They are distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. Moreover, they are suitable for controlling harmful fungi, which inter alia occur in wood or roots of plants.

The compositions according to the invention are particularly important in the control of a multitude of phytopathogenic fungi on various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or ornamental and forestry plants, such as flowers, shrubs, broad-leaved trees or evergreens, e.g. conifers; and on the plant propagation material, such as seeds, and the crop material of these plants.

Preferably the composition according to the present invention are used for controlling a multitude of fungi on field crops, such as potatoes, sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Preferably, treatment of plant propagation materials with the composition according to the present invention is used for controlling a multitude of fungi on cereals, such as wheat, rye, barley and oats; rice, corn, cotton and soybeans.

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp).

The compositions according to the invention can also be used in genetically modified plants. The term “genetically modified plants” is to be understood as hereinbefore defined.

The compositions according to the invention are particularly suitable for controlling the following plant diseases: Albugo spp. (white rust) on ornamentals, vegetables (e.g. A. candida) and sunflowers (e.g. A. tragopogonis); Alternaria spp. (Alternaria leaf spot) on vegetables, rape (A. brassicola or brassicae), sugar beets (A. tenuis), fruits, rice, soybeans, potatoes (e.g. A. solani or A. alternate), tomatoes (e.g. A. solani or A. alternate) and wheat; Aphanomyces spp. on sugar beets and vegetables; Ascochyta spp. on cereals and vegetables, e.g. A. tritici (anthracnose) on wheat and A. hordei on barley; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. olyzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthianum) and soybeans (e.g. C. truncatum or C. gloeosporiodes); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectna spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticilliodes on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella angulata on vines, pome fruits and other plants and G. gossypii on cotton; Grainstaining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemdela spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Mondinia spp., e.g. M. taxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudo-cercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or ‘rotbrenner’, anamorph: Phialophora) on vines; Puccinia spp. (rusts) on various plants, e.g. P. & Nana (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Ramularia spp., e.g. R. collo-cygni(Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e.g. S. sclerotiorum) and soybeans (e.g. S. rolfsii or S. sclerotiorum); Septona spp. on various plants, e.g. S. glycines (brown spot) on soybeans, S. tritici(Septoria blotch) on wheat and S. (syn. Stagonospora) nodorum (Stagonospora blotch) on cereals; Uncinula (syn. Erysiphe) necator (powdery mildew, anamorph: Odium tuckeri) on vines; Setospaena spp. (leaf blight) on corn (e.g. S. turcicum, syn. Helminthosporium turcicum) and turf; Sphacelotheca spp. (smut) on corn, (e.g. S. rethana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T tritici (syn. T caries, wheat bunt) and T. controversa (dwarf bunt) on wheat; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nulla and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

The compositions according to the invention are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, coiling lubricants, fiber or fabrics, against the infestation and destruction by harmful microorganisms, such as fungi and bacteria. As to the protection of wood and other materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Pona spp., Serpula spp. and Tyromyces spp., Deuteromycetes such as Aspergillus spp., Cladosporium spp., Penicillium spp., Tfichorma spp., Alternana spp., Paecilomyces spp. and Zygomycetes such as Mucor spp., and in addition in the protection of stored products and harvest the following yeast fungi are worthy of note: Candida spp. and Saccharomyces cerevisae.

The composition according to the invention are employed as such or in formulated form for treating the fungi or the plants, plant propagation materials, such as seeds, soil, surfaces, materials or rooms to be protected from fungal attack with a fungicidally effective amount of the active substances. The application can be carried out both before and after the infection of the plants, plant propagation materials, such as seeds, soil, surfaces, materials or rooms by the fungi.

Plant propagation materials may be treated with composition according to the invention as such or in formulated form prophylactically either at or before planting or transplanting.

The crop protection compositions (formulations) can be prepared and used as defined before.

Accordingly the invention also relates to crop protection compositions (formulations) comprising a solvent or solid carrier and a composition according to the present invention for the use for controlling harmful fungi.

Such formulations comprise a fungicidally effective amount of the composition according to the present invention. The term “effective amount” denotes an amount of the at least one PPO inhibitor A and the at least one respiration inhibitor B, which is sufficient for controlling harmful fungi on cultivated plants or in the protection of materials and which does not result in a substantial damage to the treated plants. Such an amount can vary in a broad range and is dependent on various factors, such as the fungal species to be controlled, the treated cultivated plant or material, the climatic conditions and the specific compound I used.

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e.g. by seed dressing, pelleting, coating and dusting.

In a preferred embodiment, a suspension-type (FS) composition is used for seed treatment. Typically, a FS composition may comprise 1-800 g/l of active substance, 1-200 g/l Surfactant, 0 to 200 g/l antifreezing agent, 0 to 400 g/l of binder, 0 to 200 g/l of a pigment and up to 1 liter of a solvent, preferably water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

In treatment of plant propagation materials such as seeds, e.g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the amount of active substance applied depends on the kind of application area and on the desired effect. Amounts customarily applied in the protection of materials are, e.g., 0.001 g to 2 kg, preferably 0.005 g to 1 kg, of active substance per cubic meter of treated material. Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

The fungicidal action of the compositions according to the present invention was demonstrated by the following experiments:

The compositions according to the present invention may also be used for improving the health of a plant.

The term “plant health” is to be understood to denote a condition of the plant and/or its products which is determined by several indicators alone or in combination with each other such as yield (e.g. increased biomass and/or increased content of valuable ingredients), plant vigor (e.g. improved plant growth and/or greener leaves (“greening effect”), quality (e.g. improved content or composition of certain ingredients) and tolerance to abiotic and/or biotic stress. The above identified indicators for the health condition of a plant may be interdependent or may result from each other.

The plants to be treated according to the invention are selected from the group consisting of agricultural, silvicultural, ornamental and horticultural plants, each in its natural or genetically modified form, more preferably from agricultural plants.

In one embodiment, the aforementioned methods for increasing the health of a plant comprises treating the plant propagules, preferably the seeds of an agricultural, horticultural, ornamental or silivcultural plant selected from the group consisting of transgenic or non-transgenic plants with a composition according to the present invention.

In one embodiment, the plant to be treated according to the method of the invention is an agricultural plant. Agricultural plants are plants of which a part or all is harvested or cultivated on a commercial scale or which serve as an important source of feed, food, fibres (e.g. cotton, linen), combustibles (e.g. wood, bioethanol, biodiesel, biomass) or other chemical compounds. Agricultural plants also horticultural plants, i.e. plants grown in gardens (and not on fields), such as certain fruits and vegetables. Preferred agricultural plants are for example cereals, e.g. wheat, rye, barley, triticale, oats, sorghum or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, juncea (Brassica juncea), linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

More preferred agricultural plants are field crops, such as potatoes, sugar beets, cereals such as wheat, rye, barley, triticale, oats, sorghum, rice and corn; cotton, rape, sunflowers, oilseed rape, juncea, canola, legumes such as soybeans, peas, beans (fieldbeans), lentil, alfalfa and clover; sugar cane, turf, ornamentals, and vegetables such as cucumbers, tomatoes, onions, leeks, lettuce and squashes. Most preferred agricultural plants are potatoes, beans (fieldbeans), alfalfa, sugar cane, turf, sugar beets, cereals such as wheat, rye, triticale, barley, oats, sorghum, rice and corn; cotton, soybeans, oilseed rape, canola, juncea, sunflower, sugar cane, peas, lentils and alfalfa; and utmost preferred plants are selected from soybean, wheat, sunflowers, canola, juncea, corn, cotton, sugar cane, peas, lentils, alfalfa and oilseed rape.

In another preferred embodiment of the present invention, the plants to be treated are selected from cucumber, soybean, wheat, sunflower, canola, oilseed rape, corn, cotton, sugar cane, juncea, peas, lentils and alfalfa. The utmost preferred plant is soybean.

In an especially preferred embodiment of the present invention, the plants to be treated are selected from cucumber, wheat, barley, corn, soybean, rice, canola and sunflower.

In another especially preferred embodiment of the present invention, the plants to be treated are selected from soybean, corn, cotton, canola, sugar cane, barley, oats, sorghum and wheat.

In one embodiment, the plant to be treated according to the method of the invention is a horticultural plant. The term “horticultural plants” are to be understood as plants which are commonly used in horticulture—e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce. Preferred vegetables are tomatoes, onions, peas and lettuce. Examples for fruits are apples, pears, cherries, strawberry, citrus, peaches, apricots and blueberries.

In one embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In one embodiment, the plant to be treated according to the method of the invention is a silvicultural plants. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm and oak.

The term “plants” also includes plants which have been modified by breeding, mutagenesis or genetic engineering (transgenic and non-transgenic plants) as defined herein. Within the herbicide tolerant plants, PPO tolerant plants, glyphosate tolerant plants and/or glufosinate tolerant plants are especially preferred.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

Within the scope of the invention, the health of a plant is increased synergistically. Thus, the term “synergistically effective amount” refers to the fact that the purely additive effect (in mathematical terms) of the application of the individual compounds is surpassed by the application of the inventive mixture. The synergistic increase of the health of a plant is more than surprising, since it can be assumed that fungicidal compounds and herbicides have completely different mode of actions.

The term “effective amount” denotes an amount of the inventive mixtures, which is sufficient for achieving the synergistic plant health effects, in particular the yield effects as defined herein. More exemplary information about amounts, ways of application and suitable ratios to be used is given below. The skilled artisan is well aware of the fact that such an amount can vary in a broad range and is dependent on various factors, e.g. the treated cultivated plant as well as the climatic and soil conditions.

The term “health of a plant” or “plant health” is defined as a condition of a plant and/or its products which is determined by several aspects alone or in combination with each other such as increased yield, plant vigor, quality and tolerance to abiotic and/or biotic stress.

Each listed plant health indicator listed herein is to be understood as a preferred embodiment of the present invention either each on its own or preferably in combination with each other.

It has to be emphasized that the above mentioned effects of the inventive compositions, i.e. enhanced health of a plant, are also present when the plant is not under biotic stress and in particular when the plant is not under pest pressure. It is evident that a plant suffering from fungal or insecticidal attack produces a smaller biomass and leads to a reduced yield as compared to a plant which has been subjected to curative or preventive treatment against the pathogenic fungus or any other relevant pest and which can grow without the damage caused by the biotic stress factor. However, the methods according to the invention lead to an enhanced plant health even in the absence of any biotic stress. This means that the positive effects of the composition of the invention cannot be explained just by the fungicidal and/or herbicidal activities of the components A, B and optionally C, but are based on further activity profiles. As a result, the application of the inventive compositions can also be carried out in the absence of pest pressure.

One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the inventive composition.

Increased yield can be characterized, among others, by the following improved properties of the plant:
increased plant weight
increased biomass such as higher overall fresh weight (FW)
increased number of flowers per plant
higher grain and/or fruit yield
more tillers or side shoots (branches)
larger leaves
increased shoot growth
increased protein content
increased oil content
increased starch content
increased pigment content
increased chlorophyll content (chlorophyll content has a positive correlation with the plant's photosynthesis rate and accordingly, the higher the chlorophyll content the higher the yield of a plant)

In a preferred embodiment, the term “yield” refers to fruits in the proper sense, vegetables, nuts, grains and seeds.

“Grain” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 5%, preferable by 5 to 10%, more preferable by 10 to 20%, or even 20 to 30%. In general, the yield increase may even be higher.

Another indicator for the condition of the plant is the plant vigor. The plant vigor becomes manifest in several aspects such as the general visual appearance.

Improved plant vigor can be characterized, among others, by the following improved properties of the plant:
improved vitality of the plant
improved plant growth
improved plant development
improved visual appearance
improved plant stand (less plant verse/lodging)
improved emergence
enhanced root growth and/or more developed root system
enhanced nodulation, in particular rhizobial nodulation
bigger leaf blade
bigger size
increased plant height
increased tiller number
increased number of side shoots
increased number of flowers per plant
increased shoot growth
increased root growth (extensive root system)
enhanced photosynthetic activity (e.g. based on increased stomatal conductance and/or increased CO2 assimilation rate)
enhanced pigment content
earlier flowering
earlier fruiting
earlier and improved germination
earlier grain maturity
less non-productive tillers
less dead basal leaves
less input needed (such as fertilizers or water)
greener leaves
complete maturation under shortened vegetation periods
less fertilizers needed
less seeds needed
easier harvesting
faster and more uniform ripening
longer shelf-life
longer panicles
delay of senescence
stronger and/or more productive tillers
better extractability of ingredients
improved quality of seeds (for being seeded in the following seasons for seed production)
reduced production of ethylene and/or the inhibition of its reception by the plant.

According to the present invention, the plant vigor is increased by at least 5%, preferable by 5 to 10%, more preferable by 10 to 20%, or even 20 to 30%. In general, the plant vigor increase may even be higher.

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention.

Enhanced quality can be characterized, among others, by following improved properties of the plant or its product:
increased nutrient content
increased protein content
increased content of fatty acids
increased metabolite content
increased carotenoid content
increased sugar content
increased amount of essential amino acids
improved nutrient composition
improved protein composition
improved composition of fatty acids
improved metabolite composition
improved carotenoid composition
improved sugar composition
improved amino acids composition
improved or optimal fruit color
improved leaf color
higher storage capacity
higher processability of the harvested products.

According to the present invention, the quality of a plant and/or its products is increased by at least 5%, preferable by 5 to 10%, more preferable by 10 to 20%, or even 20 to 30%. In general, the quality of a plant and/or its products increase may even be higher.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with an inventive mixture and (2.) that the negative effects are not diminished by a direct action of the inventive mixture on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and range from dotted leaves to total destruction of the plant. Biotic stress can be caused by living organisms, such as pests (for example insects, arachnides, nematodes) competing plants (for example weeds), microorganisms (such as phythopathogenic fungi and/or bacteria) and/or viruses.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by:
extremes in temperature such as heat or cold (heat stress/cold stress)
strong variations in temperature
temperatures unusual for the specific season
drought (drought stress)
extreme wetness
high salinity (salt stress)
radiation (for example by increased UV radiation due to the decreasing ozone layer)
increased ozone levels (ozone stress)
organic pollution (for example by phythotoxic amounts of pesticides)
inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

According to the present invention, the plant's tolerance or resistance to biotic and/or abiotic stress is increased by at least 5%, preferable by 5 to 10%, more preferable by 10 to 20%, or even 20 to 30%. In general, the plant's tolerance or resistance to biotic and/or abiotic stress increase may even be higher.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the inventive mixtures increase the yield of a plant or its product.

In a preferred embodiment of the invention, the inventive mixtures are used for increasing the the plant weight and/or the plant biomass (e.g. overall fresh weight) and/or the grain yield and/or the number of tillers.

In another embodiment the inventive mixtures increase the vigor of a plant or its product.

In another embodiment the inventive mixtures increases the quality of a plant or its product.

In yet another embodiment the inventive mixtures increases the tolerance and/or resistance of a plant or its product against biotic stress.

In yet another embodiment the inventive mixture increases the tolerance and/or resistance of a plant or its product against abiotic stress.

In a preferred embodiment, the inventive mixtures increase the tolerance and/or resistance of a plant or its product against drought stress.

In another preferred embodiment, the inventive mixtures increase the tolerance and/or resistance of a plant or its product against cold stress.

In yet another preferred embodiment, the inventive mixtures increase the tolerance and/or resistance of a plant or its product against heat stress.

One of the most important factors for the increased resistance against biotic and abiotic stress is the stimulation of the plant's natural defense reactions after the application of the inventive mixtures according to the invention.

The inventive mixtures are employed by treating the plant, plant propagation material (preferably seed), soil, area, material or environment in which a plant is growing or may grow with an effective amount of the active compounds.

The application can be carried out in the absence of pest pressure and/or both before and after an infection of the materials, plants or plant propagation materials (preferably seeds) by pests.

When preparing the mixtures, it is preferred to employ the pure active compounds, to which further active compounds against pests, such as insecticides, herbicides, fungicides or else herbicidal or growth-regulating active compounds or fertilizers can be added as further active components according to need.

As stated above, the inventive mixtures comprising compounds (I), (II) and (III) and optionally compound (IV) are used in “effective amounts”. This means that they are used in a quantity which allows to obtain the desired effect which is a synergistic increase of the health of a plant but which does not give rise to any phytotoxic symptom on the treated plant.

When applied according to the invention, the composition comprises, depending on various parameters such as the treated plant species, the weather conditions or the specific mixture:
of from 0.0005 kg/ha to 2.5 kg/ha and preferably in the range of from 0.005 kg/ha to 2 kg/ha or 0.01 kg/ha to 1.5 kg/h of a.s. of the PPO inhibitor A;
of from 0.0005 kg/ha to 2.5 kg/ha and preferably in the range of from 0.005 kg/ha to 2 kg/ha or 0.01 kg/ha to 1.5 kg/h of a.s. of the respiration inhibitor B;
0.0005 kg/ha to 2.5 kg/ha and preferably in the range of from 0.005 kg/ha to 2 kg/ha or 0.01 kg/ha to 1.5 kg/h of a.s. of the optional safener C.

As mentioned above, a variant of the present invention also comprises seed treatment with component B followed by foliar spraying with component A.

Seed treatment can be made into the seedbox before planting into the field.

In the treatment of plant propagation material (preferably seed), amounts of from 0.01 g to 3 kg, in particular amounts from 0.01 g to 1 kg of inventive composition are generally required per 100 kg of plant propagation material (preferably seed). In a preferred embodiment of the method according to the invention, amounts of from 0.01 g to 250 g of inventive composition are required per 100 kg of plant propagation material (preferably seed). In another preferred embodiment of the method according to the invention, amounts of from 0.01 g to 150 g of inventive composition are required per 100 kg of plant.

In all ternary and quaternary compositions used according to the methods of the present invention, the compounds are employed in amounts which result in a synergistic effect.

In a preferred embodiment, the pesticidal composition for increasing the health of a plant comprises a liquid or solid carrier and a mixture as described above.

For use according to the present invention, the inventive compositions can be converted into the customary formulations, for example solutions, emulsions, suspensions, dusts, powders, pastes and granules as described herein

In all compositions, uses and methods of the present invention the compositions preferably contain the at least one compound A and the at least one compound B in synergistically effective amounts, i.e. in a weight ratio of A and B such that a synergistic effect takes place. This means that the relative amount, i.e. the weight ratio of the at least one compound A and the at least one compound B in the composition provides for an increased herbicidal or fungicidal efficacy or an increased plant health effect on at least one weed or harmful fungus or plant health criterion which exceeds the additive herbicidal/fungicidal efficacy/plant health increasing effect of the compounds of the composition as calculated from the herbicidal/fungicidal efficacy/plant health increasing efficacy of the individual compounds at a given application rate. The calculation of the additive efficacies can be performed e.g. by Colby's formula (Colby, S.R. “Calculating synergistic and antagonistic responses of herbicide Combinations”, Weeds, 15, 20-22, 1967). Synergism is present if the observed efficacy is greater than the calculated efficacy.

To ensure synergism, the at least one compound of the formula A and the at least one compound B are preferably present in the compositions of the present invention in a total weight ratio of from 100:1 to 1:100, more preferably from 50:1 to 1:50, even more preferably from 20:1 to 1:20, and in particular from 10:1 to 1:10, e.g. from 5:1 to 1:5 or from 3:1 to 1:3 or from 2:1 to 1:2.

1-31. (canceled)

32. An agrochemical composition, comprising
A) at least one herbicide A selected from the protoporphyrinogen-IX oxidase (PPO) inhibitors acifluorfen, azafenidin, bencarbazone, benzfendizone, bifenox, butafenacil, carfentrazone-ethyl, chlomethoxyfen, cinidon-ethyl, ethoxyfen-ethyl, fluazolate, flufenpyr-ethyl, flumiclorac-pentyl, flumioxazin, fluoroglycofen-ethyl, fluthiacet-methyl, fomesafen, halosafen, lactofen, oxadiargyl, oxadiazon, oxyfluorfen, pentoxazone, profluazol, pyraclonil, pyraflufen-ethyl, saflufenacil, sulfentrazone, thidiazimin, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), ethyl[3-[2-chloro-4-fluoro-5-(1-methyl-6-trifluoromethyl-2,4-dioxo-1,2,3,4-tetrahydro-pyrimidin-3-yl)phenoxy]-2-pyridyloxy]acetate (CAS 353292-31-6; S-3100), N-ethyl-3-(2,6-dichloro-4-trifluoro-methylphenoxy)-5-methyl-1H-pyrazole-1-carboxamide (CAS 452098-92-9), N-tetrahydrofurfuryl-3-(2,6-dichloro-4-trifluoromethyl-phenoxy)-5-methyl-1H-pyrazole-1-carboxamide (CAS 915396-43-9), N-ethyl-3-(2-chloro-6-fluoro-4-trifluoromethyl-phenoxy)-5-methyl-1H-pyrazole-1-carboxamide (CAS 452099-05-7), N-tetrahydro-furfuryl-3-(2-chloro-6-fluoro-4-trifluoro-methylphenoxy)-5-methyl-1H-pyrazole-1-carboxamide (CAS 45100-03-7), (Z)-4-[2-Chloro-5-(4-chloro-5-difluoromethoxy-1-methyl-1H-pyrazol-3-yl)-4-fluoro-phenoxy]-3-methyl-but-2-enoic acid methyl ester,
and their agriculturally acceptable salts;
and
B) at least one fungicide B selected from the inhibitors of complex II of the respiratory chain benodanil, bixafen, boscalid, carboxin, fenfuram, fluopyram, flutolanil, fluxapyroxad, furametpyr, isopyrazam, mepronil, oxycarboxin, penthiopyrad, penflufen, sedaxane, thifluzamide, 3-difluoromethyl-1-methyl-1H-pyrazole-4-carboxylic acid (9-dichloromethylene-1,2,3,4-tetrahydro-1,4-methano-naphthalen-5-yl)-amide, and 3-difluoromethyl-1-methyl-1H-pyrazole-4-carboxylic acid (2-(2,4-dichloro-phenyl)-2-methoxy-1-methyl-ethyl)-amide.

33. The composition as claimed in claim 32, where the at least one herbicide A is selected from acifluorfen, bencarbazone, bifenox, carfentrazone-ethyl, cinidon-ethyl, flufenpyr-ethyl, flumiclorac-pentyl, flumioxazin, fluoroglycofen-ethyl, fluthiacet-methyl, fomesafen, halosafen, lactofen, oxadiargyl, oxadiazon, oxyfluorfen, pentoxazone, pyraclonil, pyraflufen-ethyl, saflufenacil, sulfentrazone, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) and their agriculturally acceptable salts.

34. The composition as claimed in claim 33, where the at least one herbicide A is selected from acifluorfen, bencarbazone, carfentrazone-ethyl, cinidon-ethyl, flufenpyr-ethyl, flumiclorac-pentyl, flumioxazin, fluoroglycofen-ethyl, fomesafen, halosafen, lactofen, oxyfluorfen, pyraflufen-ethyl, saflufenacil, sulfentrazone, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) and their agriculturally acceptable salts.

35. The composition as claimed in claim 34, where the at least one fungicide B is selected from bixafen, boscalid, fluopyram, fluxapyroxad, isopyrazam, penthiopyrad, penflufen, sedaxane, 3-difluoromethyl-1-methyl-1H-pyrazole-4-carboxylic acid (9-dichloromethylene-1,2,3,4-tetrahydro-1,4-methano-naphthalen-5-yl)-amide, and 3-difluoromethyl-1-methyl-1H-pyrazole-4-carboxylic acid (2-(2,4-dichloro-phenyl)-2-methoxy-1-methyl-ethyl)-amide.

36. The composition as claimed in claim 35, where the at least one fungicide B is selected from bixafen, boscalid, fluxapyroxad, isopyrazam, penflufen, sedaxane, and 3-difluoromethyl-1-methyl-1H-pyrazole-4-carboxylic acid (9-dichloromethylene-1,2,3,4-tetrahydro-1,4-methano-naphthalen-5-yl)-amide.

37. The composition as claimed in claim 32, where the at least one herbicide A and the at least one fungicide B are present in synergistically effective amounts.

38. The composition as claimed in claim 32, comprising additionally at least one inert liquid and/or solid carrier and optionally also at least one surface-active substance.

39. An agrochemical composition for the desiccation/defoliation of plants, comprising the composition as defined in claim 32 in such an amount that it acts as a desiccant/defoliant, and at least one inert liquid and/or solid carrier and optionally also at least one surface-active substance.

40. Seed treated with an agrochemical composition as defined in claim 32.

41. A method of controlling undesired vegetation, which comprises allowing a herbicidally effective amount of at least one composition as defined in claim 32 to act on plants or parts thereof, their environment or on propagation material.

42. A method for the desiccation and/or defoliation of plants, which method comprises treating the plants or parts thereof with an effective amount of a composition as defined in claim 32.

43. A method for controlling phytopathogenic fungi, wherein the fungi or materials, plants, parts thereof, the locus where the plants grow or are to grow or plants' propagation material to be protected from fungal attack are treated with an effective amount of a composition as defined in claim 32.

44. A method for increasing the health of at least one plant variety, which method comprises treating the plant or parts thereof, the locus where the plant grows or is to grow or propagation material from which the plant is to grow with an effective amount of a composition as defined in claim 32.

45. The method as claimed in claim 44, for increasing the plants' yield.

46. The method as claimed in claim 44, for increasing plants' tolerance against abiotic stress.

47. The method as claimed in claim 41, where the plants are selected from potatoes, sugar beets, cereals such as wheat, rye, barley, triticale, oats, sorghum, rice and corn; cotton, rape, sunflowers, oilseed rape, juncea, canola, legumes such as soybeans, peas, beans (fieldbeans), lentil, alfalfa and clover; sugar cane, turf, ornamentals, and vegetables such as cucumbers, tomatoes, onions, leeks, lettuce and squashes.

48. The method as claimed in claim 41, where the plant is an herbicide tolerant plant.

49. The method as claimed in claim 48, where the plant is tolerant against herbicides selected from the group consisting of protoporphyrinogen-IX oxidase (PPO) inhibitors, photosynthetic electron transport inhibitors at the photosystem II receptor site, acetylCoA carboxylase inhibitors (ACC inhibitors), acetolactate synthase inhibitors (ALS inhibitors), auxinic herbicides, 4-hydroxyphenylpyruvate-dioxygenase (HPPD) inhibitors, EPSP synthase inhibitors and glutamine synthase inhibitors.

50. The method as claimed in claim 49, where the protoporphyrinogen-IX oxidase inhibitor is selected from the herbicides.

51. The method as claimed in claim 49, where the photosynthetic electron transport inhibitors at the photosystem II receptor site is selected from atrazine, bromoxynil and their agriculturally acceptable esters.

52. The method as claimed in claim 49, where the acetolactate synthase inhibitor is selected from chlorimuron-ethyl, thifensulfuron-methyl, tribenuron-methyl, imazapyr, imazethapyr, imazapic, imazaquin, imazamox and their agriculturally acceptable salts.

53. The method as claimed in claim 49, where the auxinic herbicide is selected from 2,4-D, dicamba and their agriculturally acceptable salts, esters and amides.

54. The method as claimed in claim 49, where the EPSP synthase inhibitor is selected from glyphosate, sulfosate and their agriculturally acceptable salts.

55. The method as claimed in claim 49, where the glutamine synthase inhibitor is selected from glufosinate, bialafos and their agriculturally acceptable salts.

56. The method as claimed in claim 49, where the 4-hydroxy-phenylpyruvate-dioxygenase inhibitor is selected from benzobicyclone, bicyclopyrone, isoxaflutole, mesotrione, pyrasulfotole, sulcotrione, tefuryltrione, tembotrione, topramezone and their agriculturally acceptable salts.
